(19) United States
(12) Patent Application Publication
(10) Pub. No.: US 2010/0266353 A1
(43) Pub. Date: Oct. 21, 2010

(54) CUTTING INSERT COMPRISING A STABILISED DOUBLE-SIDED FACET

(76) Inventors: Wolfgang Zitzlaff, Kirchheim/Teck (DE); Raouf Ben Amor, Lorch (DE); Tina Mirus, Wurzburg (DE)

Correspondence Address: FULBRIGHT & JAWORSKI, LLP, 666 FIFTH AVE, NEW YORK, NY, 10103-3198, US

(21) Appl. No.: 12/600,851

(22) PCT Filed: May 21, 2008
(86) PCT No.: PCT/EP2008/056235

§ 371 Date: Jun. 24, 2010

(30) Foreign Application Priority Data
May 24, 2007 (DE) 102007024533.7

(51) Int. Cl. B23B 27/16

(52) U.S. Cl. 407/113

(57) ABSTRACT

A cutting insert, that is chucked in carrier tools, comprising an upper and lower face, a cutting corner with a corner radius being located on each upper and lower face, a cutting corner with a corner radius being located on each upper and lower face, between a primary cutting edge and a secondary cutting edge. To reinforce the cutting corner, which is at risk from damage during insertion, while maintaining the corner radius in relation to a cutting insert according to prior art, a stabilizing facet is provided in the cutting corner adjacent to the corner radius.

The invention relates to an indexable cutting or clamping insert for chucking or clamping in carrier tools, comprising an upper and a lower face, wherein a cutting corner with a corner radius is arranged on each upper and lower face, in each case between a main cutting edge and a secondary cutting edge.

Depending on the manner of use and intended application, it is necessary to use a very wide variety of carrier tools and indexable cutting inserts in the current prior art for machining metallic workpieces. The carrier tools mostly have one or more insert seats which are provided in order to receive the indexable cutting inserts or cutting inserts intended for this purpose. By penetrating into the workpiece surface during a rotational and feeding movement of the tool or workpiece, the indexable cutting insert used carries out the desired material removal.

Important machining criteria are, for example, secure fastening of the indexable cutting insert to the carrier tool, the selection of the correct rotational speeds and feeding values on the machine and, above all, the selection of the correct cutting material for the indexable cutting insert, as well as the chip form geometry and the quality of the cutting edge. Indexable cutting inserts are mostly produced from hard materials such as ceramics, mixed ceramics, hard metals, cubic boron nitride or polycrystalline diamond. The higher the stability of the cutting edge selected for the indexable cutting insert, the greater the power of the machine required for the machining. The stability is provided by large wedge angles of the indexable cutting insert, large corner radii or cutting-edge beveling or cutting-edge rounding.

Furthermore, the fastening and position of the indexable cutting insert in the insert seat is decisive. Since the indexable cutting inserts are designed with a hole, trough or smooth surface, they are usually fastened by screwing or clamping by means of a clamping wedge or clamping lugs. The position in the carrier tool is defined via the setting angle of the main cutting edge and the rake angle and angle of inclination in relation to the main cutting edge.

The invention is based on the object of improving an indexable cutting insert according to the preamble of claim 1 in such a way as to reinforce the cutting corner at risk from damage during use, whilst substantially maintaining the corner radius with respect to an indexable cutting insert according to the prior art. At the same time, the basic shape of the indexable cutting insert should also be retained, as a result of which the existing carrier tool can continue to be used.

According to the invention, this object is achieved by arranging a stabilizing facet in the cutting corner adjacent to the corner radius. In addition, this also makes it possible for the corner radius to be substantially maintained with respect to an indexable cutting insert according to the prior art. At the same time, the basic shape of the indexable cutting insert can also be retained, as a result of which the available carrier tool can continue to be used.

In one refinement of the invention, the facet has a substantially rectangular design and extends from an upper or lower face as far as the center plane of the indexable cutting insert. As a result, the facet has a maximum size.

In a further refinement of the invention, the facet adjoins the corner radius tangentially, has a rectilinear to slightly convex design, as seen in relation to the center of the insert, and merges with a tangentially adjoining transitional radius into the secondary cutting edge.

In a further refinement of the invention, the facet has a length of 0.2 mm to 2.0 mm, as seen in the circumferential direction of the cutting insert, and serves in particular as a secondary main cutting edge.

In a preferred embodiment, the facet is horizontal or inclined at an angle between ±5° in relation to the fictive workpiece surface.

In relation to a line running perpendicularly to the upper or lower face, the facets are preferably arranged mirror-symmetrically in relation to one another on the cutting corners situated opposite in relation to the center plane of the cutting insert. This decisively increases the number of utilizable cutting edges.

In one refinement of the invention, the corner radius of an upper or lower face of the cutting insert merges, via an inwardly inclined secondary facet, into the facet of the cutting corner situated opposite in relation to the center plane of the cutting insert.

According to the invention, the indexable cutting insert has twice as many utilizable main cutting edges and secondary cutting edges as cutting corners and, as a result, can be indexed.

The indexable cutting insert preferably has a triangular, square or rhombic basic shape.

In a further refinement of the invention, the indexable cutting insert has a pentagonal to octagonal basic shape.

The transitional radius of the facet to the secondary cutting edge is preferably less than or equal to the corner radius.

The facet preferably has a convex design and is equivalent to a radius portion between R=20 mm and R=100 mm.

Further features of the invention emerge from the Figures which are described below.

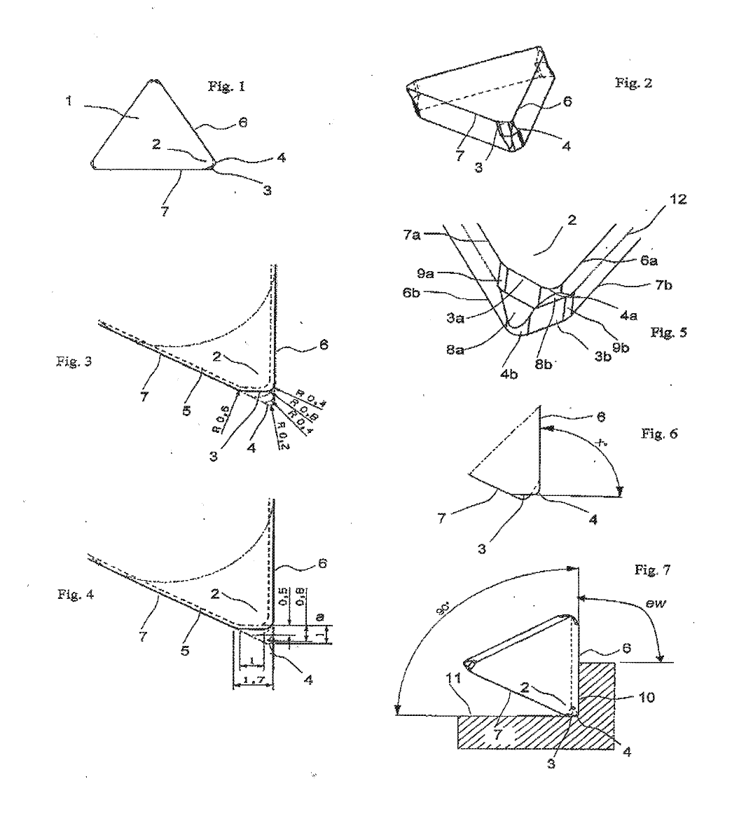

The invention relates to an indexable cutting insert 1 having a facet 3 which is provided on both sides in order to stabilize the cutting corner 2 (see FIG. 1). The cutting corner 2 is located in each case between the so-called main cutting edge 6 and the secondary cutting edge 7. This special facet 3 shortens the cutting corner 2 otherwise formed by a corner radius 4 and thus makes it possible to reinforce and stabilize the cutting corners 2 without impairing the basic shape of the indexable cutting insert 1 and the actual size of the corner radius 4 and its functionality.

The smaller the included angle of an indexable cutting insert (90° to 35° are customary here), the greater the stabilizing effect of the facet 3 according to the invention. By way of example, FIG. 1 shows this special facet 3 on a triangular indexable cutting insert having an included angle of 60°. The orientation of the facet 3 is adapted in each case specifically to the position in which the indexable cutting insert 1 is subsequently installed in an associated carrier tool, is matched to the common functionality and forms a secondary main cutting edge in terms of machining and operation. The carrier tools used are mostly surface milling cutters or cutter heads. Use for turning is also conceivable in the case of suitable carrier tools. In this invention, importance has been attached to maintaining the use of insert seats standardized to DIN-ISO in carrier tools, so that the user can make use of the largest possible range of standardized indexable cutting inserts. The benefit and additional value for the user here is more the exchangeable indexable cutting insert 1 which has the highest possible stability, functionality, efficiency and cost-efficiency owing to its inventive features.

For further explanation, FIG. 3 illustrates a schematic view showing the position of an indexable cutting insert 1 in a fictive insert seat. The dash-dotted lines indicate the form of the cutting corner of a conventional indexable cutting insert 1 with corner radius. In the case of small corner radii 4 (less than R=1.2 mm), the cutting corner 2 of the indexable cutting insert 1 protrudes by virtue of its geometry far beyond the end edge of the bearing surface 5, also referred to below as the insert seat edge, of the insert seat (indicated by the dashed lines). The bearing cross section q of the overhang on the cutting corner 2 inevitably becomes smaller as the corner radius 4 is reduced. As the distances between the insert seat edge 5 and the corner radius 4 become larger (see FIG. 4), the indexable cutting insert corner 2 becomes more susceptible to chipping or complete failure due to fracture of the overhang, which in the worst-case scenario can lead to the workpiece becoming damaged. This does not afford reliable and low-cost machining of the component. A certain overhang or smaller substructure of the carrier tool is necessary so as not to restrict excessively the selection of indexable cutting inserts on the carrier tool. A small corner radius 4 or a side wall of 90° cannot always be avoided during machining and is often desirable, since some workpieces or a lack of machine power necessitate this.

Therefore, this invention is based on the object of reinforcing the cutting corner 2 at risk from damage by providing a facet 3, with the advantage that the actually desired small corner radius 4 of 0.2 mm to 1.2 mm is, in principle, maintained at the cutting corner 2 of the indexable cutting insert 1. At the same time, the required basic shape of the indexable cutting insert 1 is also retained. According to the invention, this makes it possible for the available carrier tool to continue to be used, and the overhang described above, defined by the possible distances a, can additionally be greatly reduced (see FIG. 4). The cross section q of the overhang is also increased by using the facet 3, so that the rigidity and fracture resistance of the cutting corner 2 is decisively increased. On account of its position in the carrier tool (see FIG. 7) and the required setting angle of 90°, this facet 3 is provided on the cutting corner 2 asymmetrically and horizontally with respect to the subsequent effective direction. Experience shows that this asymmetry halves the number of cutting corners 2 that can be used in the case of a negative indexable cutting insert 1. In order to make it possible again to use the greatest possible number of cutting corners 2 in the case of this present indexable cutting insert 1, the invention provides that the facet 3 is also provided on the opposite region on the rear side of the cutting corner 2 in mirror-inverted fashion, i.e. in double-sided fashion. This is shown and explained further in FIG. 5.

The reference signs provided with the suffix a or b, such as 3a, 3b or 4a, 4b or 6a, 6b or 7a, 7b or 8a, 8b or 9a, 9b, each denote identical but mirror-symmetrically arranged objects.

In relation to a line running perpendicularly to the upper or lower face, the facets 3 are arranged mirror-symmetrically in relation to one another on the cutting corners situated opposite in relation to the center plane 12 of the cutting insert 1.

The secondary facets 8a and 8b between the facets 3a/3b and corner radii 4b/4a are angled slightly in the transition to the opposite, mirrored arrangement, protrude out of the lateral surface of the corner radii 4a/4b and, according to the invention, serve to help stabilize the corner radii 4a/4b. Without these special secondary facets 8, it would not be possible for the main cutting edges 2, the secondary main cutting edges formed by the facets 3 and the number of cutting corners doubled as a result to operate.

A further feature of these stabilizing, double-sided facets 3 and secondary facets 8 that can be mentioned is the actual corner radius 4 which merges into the main cutting edge 6 from the facet 3 and can also subsequently be determined as a feature on the machined workpiece. At the opposite end of the facet 3, mention should also be made of the transitional radius 9 which leads tangentially out of the facet surface and merges into the secondary cutting edge 7 with a size which is virtually similar to the corner radius 4a, 4b itself. The facet 3 usually has a length between 0.2 mm and 2.0 mm and, in the ideal case, is rectilinear or has a slightly convex curvature. The curvature then has a radial or elliptical shape with a radius that is expediently R=20 mm to R=100 mm, depending on the magnitude of the facet length. The cutting corner 2 is usually positioned between the main cutting edge 6 and the secondary cutting edge 7, the main cutting edge and the secondary cutting edge being at a defined angle with respect to one another. In the case of the triangular indexable cutting insert 1 described here by way of example, this angle is 120°. Depending on the type of indexable insert, e.g. rhombic and square forms can be mentioned here, the included angle is 35°, 55°, 75°, 80° or 90°. As shown in this case, the orientation of the facet 3 is, for example, between 89° and 91° with respect to the main cutting edge 6.

These facets 3 and secondary facets 8 and radii (corner radius 4 and transitional radius 9) as well as the entire circumferential region of the indexable cutting insert 1 are usually provided by hard-machining, e.g. grinding or laser machining. Direct pressing-in and pressing-on using correspondingly formed sets of punches and dies as well as sets of injection-molding tools or other non-cutting or material-removing processes and subsequent sintering processes and hard-machining processes are also conceivable.

The special feature of the triangular indexable cutting insert 1 described here, with the facets 3 and secondary facets 8 according to the invention, is that it is especially suitable for use in milling using rotating carrier tools. It makes it possible to produce a rectangular shoulder on the machined components (see FIG. 7), e.g. by means of the setting angle ew of 90° of the main cutting edge 6 and suitable rake angles and angles of inclination of 5° to 15° of the main cutting edge 6. In addition, the position and length, according to the invention, of the facet 3 in the cutting corner 2, which is preferably to be provided at an angle of 80° to 95° with respect to the main cutting edge 6, provide the function of a secondary main cutting edge. After the machining operation, this results in a high surface quality with small peak-to-valley heights on the flat surface of the workpiece. This special facet 3 also makes it possible to obtain outstanding surface quality on the workpiece, with the machine using less power, by means of small corner radii 4 of 0.2 mm to 0.4 mm, during rough machining or rough finish machining, together with high feeding values and as a result of the small corner radius 4. This makes it possible to satisfy the user's demand for low-cost indexable cutting inserts, with as many utilizable cutting edges and cutting corners as possible for machines with reduced power. The use of this stabilizing facet 3 and the assisting secondary facets 8, together with high feeding values and reduced power consumption, makes it possible to achieve a comparatively quicker machining time as compared with conventional indexable cutting inserts 1 having this basic shape. More efficient and economic machining of the workpiece is possible together with a comparably constant or even improved surface quality.

The facets 3a and 3b, the transitional radii 9a and 9b and the corner radii 4a and 4b have the same size. In FIG. 5, the surfaces are deformed owing to the perspective illustration.

WO 03/013770 A1 discloses a cutting insert having a clamping trough which has a circular design and has a spherical or circular elevation in the center. The elevation is preferably above the bottom of the trough and underneath the upper face of the cutting insert. For chucking on a cutting tool, a clamping lug engages with an appropriately formed nose into the trough of the cutting insert with a form fit. This trough serves for clamping on a carrier body with a form fit. This cutting insert with the special trough is particularly suitable for pulling cuts in which the cutting insert might be pulled out of its seat by the effective cutting forces. In one embodiment, the cutting insert according to the invention, in accordance with this application, is provided with this clamping trough.

EP 1 536 903 B1 describes a cutting insert for chucking in a cutting tool for machining cast materials, comprising a cutting insert upper face, a first clamping trough for chucking in the cutting tool and a cutting edge for chip-removing machining. So that lapping or grinding of the cutting insert upper face does not influence the clamping properties of the cutting insert, a second clamping trough is arranged coaxially to the first clamping trough, wherein the first clamping trough is arranged deeper than the second clamping trough, and the two clamping troughs are arranged deeper than the cutting insert upper face. When this cutting insert is clamped in a tool, a clamping lug of the tool rests against the second clamping trough and engages, for example with a nose, in the first clamping trough. In one embodiment, the cutting insert according to the invention, in accordance with this application, is provided with these two clamping troughs.

WO 2005/021192 A1 describes a cutting insert made from PCBN or a CBN composite material, wherein the cutting insert has a clamping trough. The clamping trough may have a circular design and may have a spherical or circular elevation in the center. The corresponding contour of the clamping trough is preferably introduced via a corresponding shaping of the green body and the green body produced in this way is then dried and sintered. In one embodiment, the cutting insert according to the invention, in accordance with this application, is produced as described. The cutting insert according to the invention may also be provided with a coating.

1-12. (canceled)

13. An indexable cutting insert for chucking in carrier tools, comprising:
an upper and a lower face;
wherein a cutting corner having a corner radius is arranged on the upper face and the lower face, in each case between a main cutting edge and a secondary cutting edge;
and a stabilizing facet arranged in the cutting corner adjacent to the corner radius.

14. An indexable cutting insert as claimed in claim 13, wherein the stabilizing facet has a substantially rectangular design and extends from an upper or lower face as far as the center plane of the indexable cutting insert.

15. An indexable cutting insert as claimed in claim 13, wherein the stabilizing facet adjoins the corner radius tangentially, has a rectilinear to slightly convex design, as seen in relation to the center of the insert, and merges with a tangentially adjoining transitional radius into the secondary cutting edge.

16. An indexable cutting insert as claimed in claim 13, wherein the stabilizing facet has a length of 0.2 mm to 2.0 mm, as seen in the circumferential direction of the cutting insert, and serves in particular as a secondary main cutting edge.

17. An indexable cutting insert as claimed in claim 13, wherein the stabilizing facet is horizontal or inclined at an angle between ±5° in relation to a workpiece surface.

18. An indexable cutting insert as claimed in claim 13, wherein, in relation to a line running perpendicularly to the upper or lower face, the facets are arranged mirror-symmetrically in relation to one another on the cutting corners situated opposite in relation to the center plane of the cutting insert.

19. An indexable cutting insert as claimed in claim 13, wherein the corner radius of an upper or lower face merges, via an inwardly inclined secondary facet, into the stabilizing facet of the cutting corner situated opposite in relation to the center plane of the cutting insert.

20. An indexable cutting insert as claimed in claim 13, wherein the indexable cutting insert has twice as many utilizable main cutting edges and secondary cutting edges as cutting corners and, as a result, can be indexed.

21. An indexable cutting insert as claimed in claim 13, wherein the indexable cutting insert has a triangular, square or rhombic basic shape.

22. An indexable cutting insert as claimed in claim 13, wherein the indexable cutting insert has a pentagonal to octagonal basic shape.

23. An indexable cutting insert as claimed in claim 13, wherein the transitional radius of the stabilizing facet to the secondary cutting edge is less than or equal to the corner radius.

24. An indexable cutting insert as claimed in claim 13, wherein the stabilizing facet has a convex design and is equivalent to a radius portion between R=20 mm and R=100 mm.
